(19) United States
(12) Patent Application Publication
(10) Pub. No.: US 2011/0162749 A1
(43) Pub. Date: Jul. 7, 2011

(54) RESIN HOSE

(76) Inventor: Inseon Jeong, Namyangju-si (KR)

(21) Appl. No.: 13/119,745

(22) PCT Filed: Sep. 19, 2009
(86) PCT No.: PCT/KR2009/005346

§ 371 Date: Mar. 18, 2011

(30) Foreign Application Priority Data
Sep. 19, 2008 (KR) 10-2008-0092454

(51) Int. Cl. F16L 11/08

(52) U.S. Cl. 138/125

(57) ABSTRACT

The present invention provides a resin hose for transporting a fluid, said hose comprising: an inner tube made of resin; an outer tube made of resin; and a fabric reinforcement layer interposed between the inner tube and the outer tube. The fabric reinforcement layer includes a first reinforcement member and a second reinforcement member intersecting each other. The reinforcement members are formed of threads different in size, ply, or yarn count. As each of the reinforcement members is formed of threads different in size, ply, or yarn count, adhesion between the inner tube and the outer tube can be increased even without increasing the volume of total threads, and the pressure resistance of the hose can be improved.

### TECHNICAL FIELD

The present invention relates, in general, to hoses for transporting fluid and, more particularly, to a resin hose having a fabric reinforcement layer which is interposed between an inner tube and an outer tube.

### BACKGROUND ART

Hoses are tubes that are made of a variety of materials, such as rubber, resin, or cloth, so as to bend freely. Hoses are widely used to convey fluid such as water, gas, or mobile earth and sand.

Among the hoses, a resin hose is constructed so that a fabric reinforcement layer is interposed between an inner tube and an outer tube which are made of rubber or resin to increase the strength.

The resin hose must satisfy the following requirements: that there be enough strength to endure a predetermined pressure, and a long life attributable to high adhesive strength between the inner and outer tubes, and superior flexibility attributable to the inner and outer tubes made of soft rubber or resin.

Various kinds of conventional resin hoses have been used. One example of the conventional resin hoses is shown in FIGS. 1 and 2.

Referring to FIGS. 1 and 2, the conventional resin hose 10 includes an inner tube 12 and an outer tube 16 which are made of rubber or resin, with a fabric reinforcement layer 14 being disposed between the inner and outer tubes. The fabric reinforcement layer 14 is formed by intersecting a first directional thread 14a with a second directional thread 14b, and functions to provide a proper degree of flexibility while increasing the strength of the hose.

However, the conventional resin hose 10 is problematic in that the gap between threads of the reinforcement layer 14 is too large. If the gap between the threads is large, adhesive strength of resin between the inner and outer tubes 12 and 16 is good, but the strength of the reinforcement layer 14 is reduced and thus pressure resisted by the hose 10 is low.

FIG. 3 is a perspective view showing another conventional resin hose.

Referring to FIG. 3, the resin hose 20 includes an inner tube 22 and an outer tube 26 which are made of rubber or resin, with a fabric reinforcement layer 24 being disposed between the inner and outer tubes. The fabric reinforcement layer 24 is formed by intersecting one pair of first directional threads 24a and 24b with one pair of second directional threads 24c and 24d.

The fabric reinforcement layer 24 made by two pairs of threads is advantageous in that the strength of the reinforcement layer 24 is high and that the pressure that can be withstood by the hose 20 is also increased. However, it is problematic because the amount of threads used increases, so that the weight of the hose 20 increases, and because the gap between the threads is small so that adhesive strength is low. Further, since the amount of threads increases and the threads are arranged compactly, it is difficult to maintain flexibility.

FIG. 4 is a perspective view showing a further conventional resin hose.

Referring to FIG. 4, the resin hose 30 includes an inner tube 32, an intermediate tube 36, and an outer tube 40 which are made of rubber or resin, with first and second fabric reinforcement layers 34 and 38 being disposed, respectively, between the tubes. That is, the first fabric reinforcement layer 34 is interposed between the inner and intermediate tubes 32 and 36, and the second fabric reinforcement layer 38 is interposed between the intermediate and outer tubes 36 and 40.

Since the intersecting arrangement of each fabric reinforcement layer 34 or 38 is identical with that of FIGS. 1 and 2, it will not be shown nor described herein.

The conventional resin hose shown in FIG. 4 is constructed to have a double fabric reinforcement structure, that is, two fabric reinforcement layers 34 and 38. This makes the resin hose advantageous in that the reinforcement layers 34 and 38 increase the overall strength, so that the hose 30 may withstand larger pressure. However, this resin hose is problematic in that the intermediate tube 36 is used and the two fabric reinforcement layers 34 and 38 are provided, so that the entire weight of the hose 30 increases.

### DISCLOSURE

### Technical Problem

Accordingly, the present invention has been made keeping in mind the above problems occurring in the prior art, and an object of the present invention is to provide a fluid transporting resin hose having a fabric reinforcement layer between an inner tube and an outer tube, in which the fabric reinforcement layer is made by intersecting a first group of threads with a second group of threads, and each group includes threads that are different in thickness or twisting number from each other, thus increasing adhesive strength between the inner tube and the outer tube without increasing the total amount of threads.

### Technical Solution

In order to accomplish the above object, the present invention provides a resin hose for transporting fluid, including an inner tube made of resin; an outer tube made of resin; and a fabric reinforcement layer interposed between the inner tube and the outer tube.

The fabric reinforcement layer may include a first directional reinforcement member and a second directional reinforcement member. Each reinforcement member may include threads which have different thicknesses or twisting numbers.

The first and second directional reinforcement members may be woven or knitted.

Further, the threads of the first and second directional reinforcement members may be formed in the same over and under pattern, or may be formed in different over and under patterns.

In the resin hose of the present invention, when the reinforcement members are woven or knitted, two or more strands of threads may be doubled to form one strand of thread. The two or more strands of threads forming one strand of thread may comprise threads which have different thicknesses or different twisting numbers.

When the first and second directional reinforcement members are woven or knitted, threads which are doubled into one strand of thread may have the same arrangement or they may have different arrangements.

In the resin hose of the present invention, when the reinforcement member includes three strands of threads which have different thicknesses and are doubled into one strand of thread, the three strands of threads may have the relative fineness ratio of 1:1.5:2.

### Advantageous Effects

As described above, a resin hose for transporting fluid according to the present invention is advantageous in that a fabric reinforcement layer is formed by intersecting first and second directional reinforcement members, comprising threads, with each other, and each reinforcement member is made of threads of different thicknesses or twisting number from each other, thus increasing adhesive strength between an inner tube and an outer tube without increasing the total amount of threads, in addition to increasing the capacity to withstand pressure.

Further, a resin hose is advantageous in that adhesive strength between an inner tube and an outer tube increases, so that the outer tube becomes removed less often when the resin hose is being used, thereby increasing the life of the resin hose.

Furthermore, a resin hose is advantageous in that the amount of thread is not increased, so that a reduction in flexibility of the resin hose is prevented.

Moreover, a resin hose is advantageous in that threads of each reinforcement member have different thicknesses or different twisting numbers, so that the flexibility of the resin hose is increased and adhesion between the inner tube and the outer tube is further strengthened, by unevenness and friction caused by a difference in thickness between the threads.

### DESCRIPTION OF DRAWINGS

FIG. 1 is a perspective view showing a conventional resin hose for transporting fluid;

FIG. 2 is a sectional view taken along line A-A of FIG. 1;

FIG. 3 is a perspective view showing another conventional resin hose for transporting fluid;

FIG. 4 is a perspective view showing a further conventional resin hose for transporting fluid;

FIG. 5 is a perspective view showing a resin hose for transporting fluid according to a first embodiment of the present invention;

FIG. 6 is a perspective view showing a resin hose for transporting fluid according to a second embodiment of the present invention;

FIG. 7 is a sectional view taken along line B-B of FIG. 5; and

FIG. 8 is a sectional view showing a resin hose for transporting fluid according to a third embodiment of the present invention.

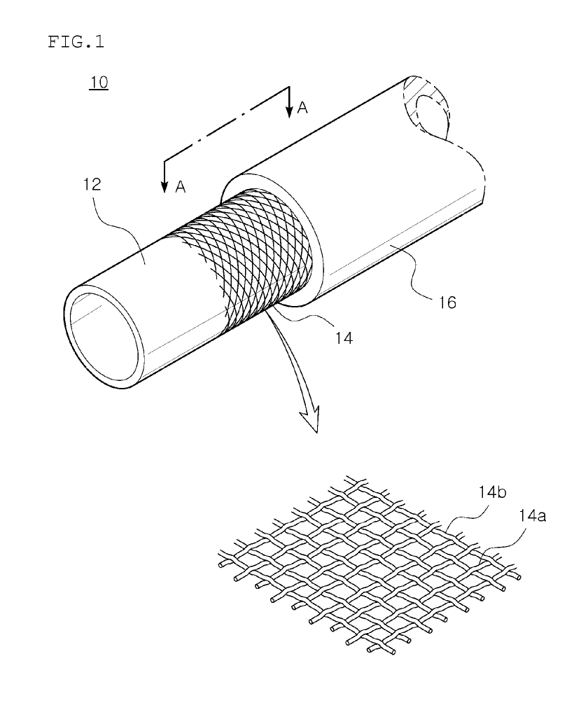

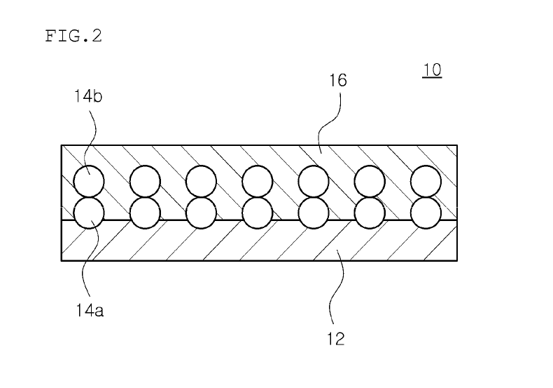

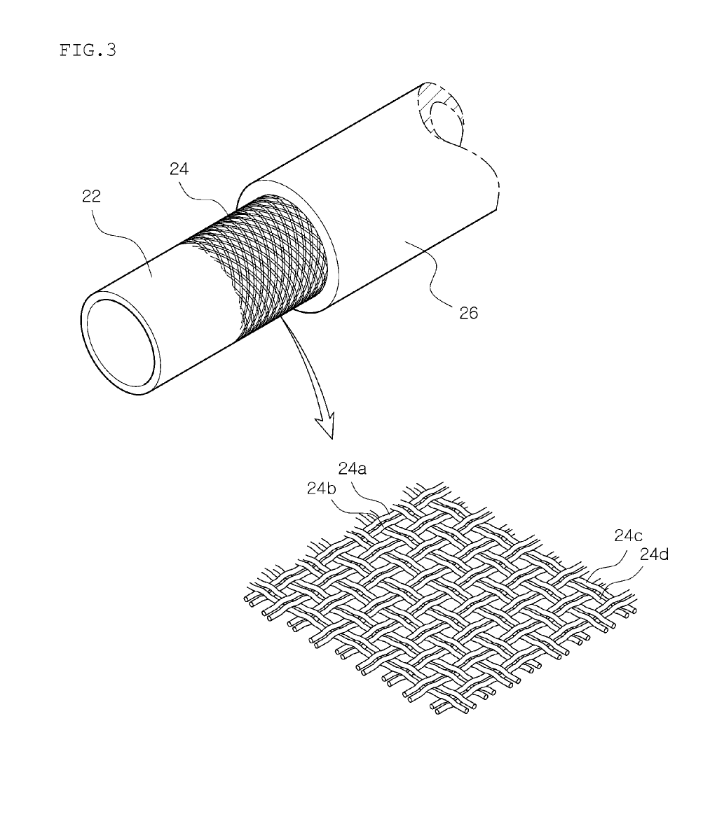

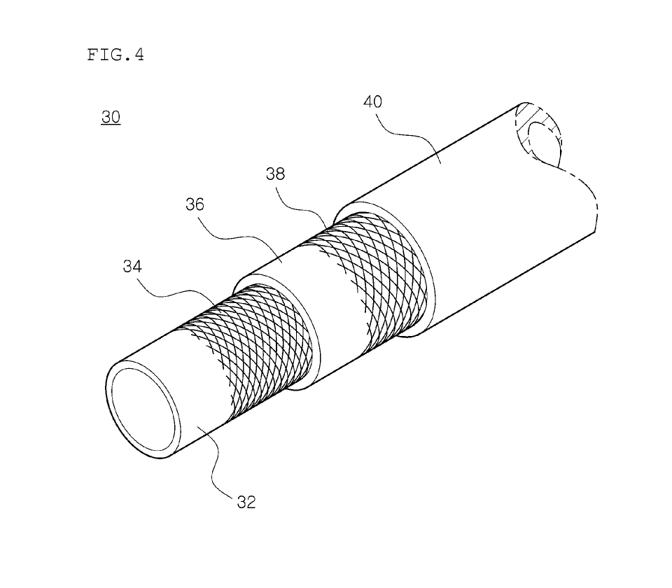

### DESCRIPTION OF REFERENCE CHARACTERS OF IMPORTANT PARTS

100, 200: resin hose
120, 220: inner tube
140, 240: fabric reinforcement layer
160, 260: outer tube
142a, 142b, 242a, 242b, 242c: first directional thread
144a, 144b, 244a, 244b, 244c: second directional thread

### MODE FOR INVENTION

Hereinafter, a resin hose for transporting fluid according to the embodiment of the present invention will be described in detail with reference to the accompanying drawings.

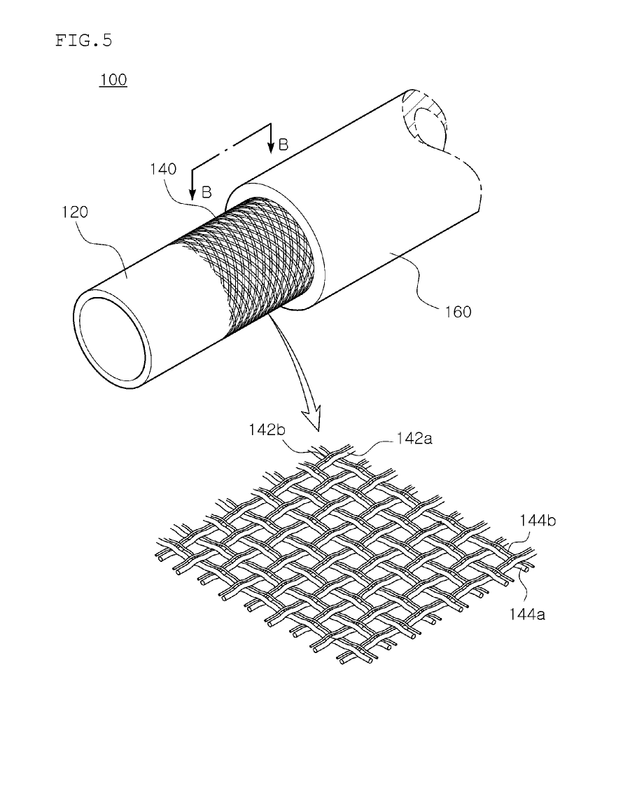

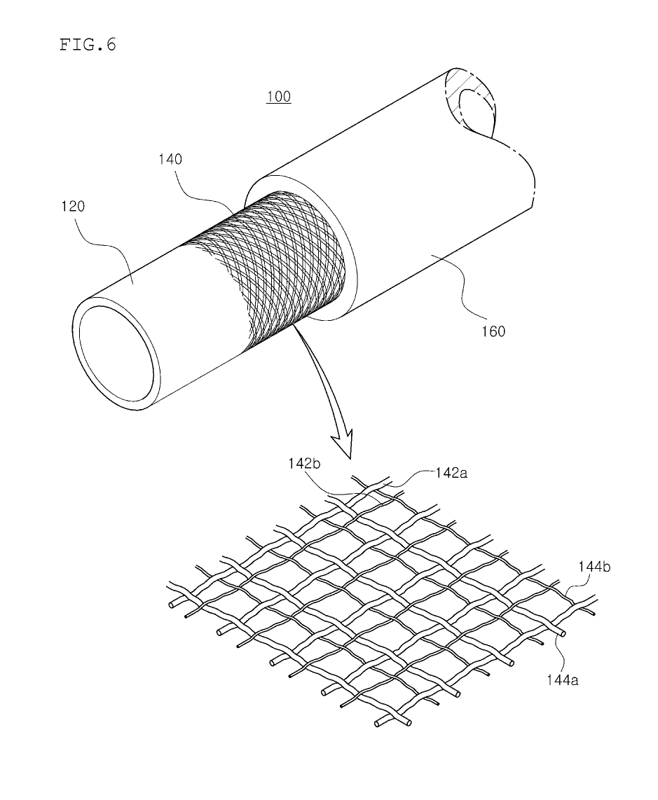

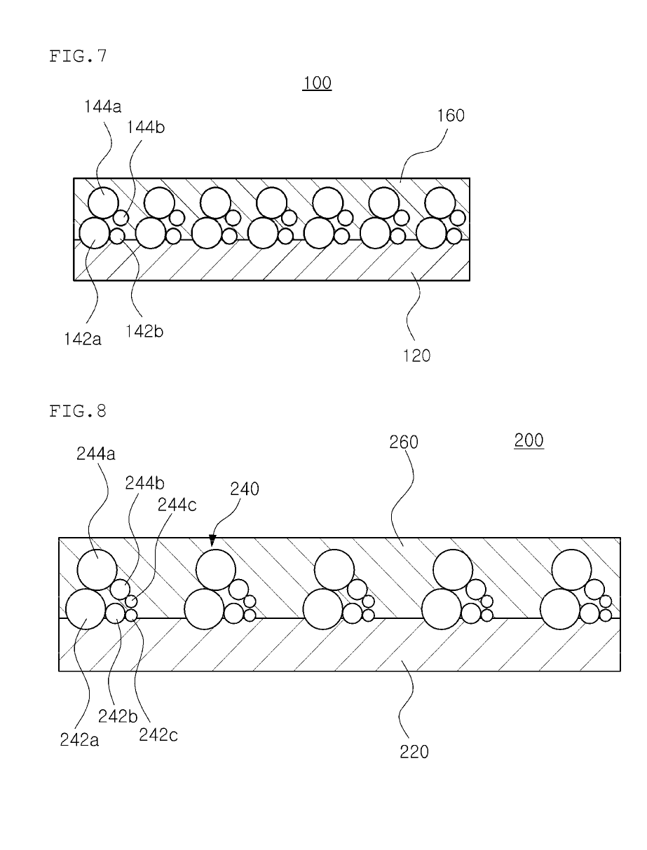

FIG. 5 is a perspective view showing a resin hose for transporting fluid according to a first embodiment of the present invention, FIG. 6 is a perspective view showing a resin hose for transporting fluid according to a second embodiment of the present invention, and FIG. 7 is a sectional view taken along line B-B of FIG. 5.

First, referring to FIGS. 5 and 7, the resin hose 100 for transporting fluid according to the present invention includes an inner tube 120 and an outer tube 160 which are made of resin, and a fabric reinforcement layer 140 which is interposed between the inner and outer tubes. Here, the fabric reinforcement layer is woven using one strand of thread obtained by doubling two strands of threads 142a and 142b or 144a and 144b in one bobbin.

The fabric reinforcement layer 140 includes a first directional reinforcement member 142a and 142b and a second directional reinforcement member 144a and 144b, which intersect each other. The first directional reinforcement member 142a and 142b includes first and second threads 142a and 142b which have different thicknesses from each other. The first thread 142a is thicker than the second thread 142b. The second directional reinforcement member 144a and 144b includes first and second thread 144a and 144b which have different thicknesses from each other. The first thread 144a is thicker than the second thread 144b.

The first and second threads of each reinforcement member are arranged in the same over and under pattern. As shown in FIG. 5, the first and second threads 142a and 142b of the first directional reinforcement member 142a and 142b having the same over and under pattern are interwoven with the first and second threads 144a and 144b of the second directional reinforcement member 144a and 144b. Further, the first and second threads 144a and 144b of the second directional reinforcement member 144a and 144b having the same over and under pattern are also interwoven with the first and second threads 142a and 142b of the first directional reinforcement member 142a and 142b.

However, the first and second threads of each reinforcement member may be arranged in different over and under patterns. Although not shown in the drawings, the first and second threads 142a and 142b of the first directional reinforcement member 142a and 142b having different over and under patterns may be interwoven with the first and second threads 144a and 144b of the second directional reinforcement member 144a and 144b. The first and second threads 144a and 144b of the second directional reinforcement member 144a and 144b having different over and under patterns may also be interwoven with the first and second threads 142a and 142b of the first directional reinforcement member 142a and 142b.

Hereinbefore, the threads of the first and second directional reinforcement members, which are doubled into one strand, have the same arrangement. That is, the first thread 142a of the first directional reinforcement member has the same thickness as the first thread 144a of the second directional reinforcement member, and the second thread 142b of the first directional reinforcement member has the same thickness as the second thread 144b of the second directional reinforcement member. However, the thickness of the first thread 142a of the first directional reinforcement member may be different from that of the first thread 144a of the second directional reinforcement member, and the thickness of the second thread 142b of the first directional reinforcement member may be different from that of the second thread 144b of the second directional reinforcement member. Thereby, the threads of the first and second directional reinforcement members, which are doubled into one strand, may have different arrangements.

The reason why the first threads 142a and 144a are formed to be different in thickness from the second threads 144a and 144b is as follows.

The pressure resisting capacity of the resin hose is proportional to the amount and strength of the threads. Since the cross-section of a thread approximates a circular shape, the amount of the thread is proportional to the square of the radius of the thread. Thus, if two threads with different thicknesses are arranged without changing the total amount of threads, the entire width of the threads is smaller than that of two threads with the same thickness. Meanwhile, the narrower the entire width of the threads is, the larger is the area of direct contact between the inner and outer tubes of the hose. As a result, adhesive strength between the inner and outer tubes increases.

As such, if the thicknesses of the first threads 142a and 144a are different from those of the second threads 142b and 144b or if the respective threads 142a, 142b, 144a, and 144b have different thicknesses, adhesive strength between the inner and outer tubes 120 and 160 increases, and thus the strength and pressure resisting capacity of the resin hose are improved.

Since adhesive strength between the inner and outer tubes increases, the outer tube becomes removed less often when the resin hose is being used, and thus the life of the resin hose is prolonged. Further, since the amount of the threads does not increase, the flexibility of the resin hose is not reduced. Moreover, since the threads of each reinforcement member have different thicknesses, the flexibility of the resin hose increases and adhesion between the inner and outer tubes is further strengthened because of unevenness and friction caused by a difference in thickness between the threads.

Here, the first thread 142a or 144a and the second thread 144a or 144b may have various thickness ratios, for example, the ratio of 1:⅕ to 1:⅘. It is preferable to apply the thickness ratio of about 1:½.

In FIG. 5, the first directional reinforcement member 142a and 142b and the second directional reinforcement member 144a and 144b are woven, but they may be knitted.

Meanwhile, FIG. 6 shows the second embodiment of the present invention. The resin hose 100 for transporting fluid according to this embodiment includes an inner tube 120 and an outer tube 160 which are made of resin, and a fabric reinforcement layer 140 which is interposed between the inner and outer tubes. Here, the fabric reinforcement layer is woven using one strand of thread 142a, 142b, 144a and 144b unwound from one bobbin. Since the construction and operation of the second embodiment are equal or similar to those of the embodiment shown in FIG. 5, a detailed description will be omitted.

FIG. 8 is a sectional view showing a resin hose for transporting fluid according to a third embodiment of the present invention.

Referring to FIG. 8, the resin hose 200 for transporting fluid according to the third embodiment of the present invention includes an inner tube 220 and an outer tube 260 which are made of resin, and a fabric reinforcement layer 240 which is interposed between the inner and outer tubes.

The fabric reinforcement layer 240 includes a first directional reinforcement member 242a, 242b, and 242c and a second directional reinforcement member 244a, 244b, and 244c which intersect each other. The first directional reinforcement member 242a, 242b, and 242c includes a first thread 242a, a second thread 242b, and a third thread 242c which have different thicknesses. Here, the thicknesses are reduced in the sequence of the first thread 242a, the second thread 242b, and the third thread 242c. The second directional reinforcement member 244a, 244b, and 244c includes a first thread 244a, a second thread 244b, and a third thread 244c which have different thicknesses. Here, the thicknesses are reduced in the sequence of the first thread 244a, the second thread 244b, and the third thread 244c.

Here, the respective threads 242a, 242b, and 242c of the first directional reinforcement member are doubled to be used as one strand of thread. Similarly, the respective threads 244a, 244b, and 244c of the second directional reinforcement member are doubled to be used as one strand of thread.

Further, although not shown in the drawing, the thicknesses of the respective threads 242a, 242b, 242c, 244a, 244b, and 244c may be different from each other. Such a construction may also achieve the object of the present invention.

If the number of threads of each group increases, the strength of the fabric reinforcement layer 240 increases, so that the overall pressure resisting capacity of the resin hose 200 may be increased.

Of course, the number of threads of each group may be changed variously depending on the purpose and specification of the resin hose. Although the number of threads of each group varies, its characteristics and effects are substantially identical with those of the above-mentioned embodiment shown in FIG. 5, 6 or 8. A change in number, thickness, or twisting number of threads falls within the purview of the present invention.

1. A resin hose for transporting fluid, comprising:
an inner tube made of resin;
an outer tube made of resin; and
a fabric reinforcement layer interposed between the inner tube and the outer tube,
the fabric reinforcement layer comprising a first directional reinforcement member and a second directional reinforcement member which intersect each other, the first directional reinforcement member comprising two or more strands of threads which are different in thickness or twisting number from each other, form one unit and are repeatedly arranged, the second directional reinforcement member comprising threads which have the same thickness and are woven or knitted with the threads of the first directional reinforcing member.

2. The resin hose according to claim 1, wherein the second directional reinforcement member comprises two or more strands of threads which are different in thickness or twisting number from each other, form one unit and are repeatedly arranged.

3. A resin hose for transporting fluid, comprising:
an inner tube made of resin;
an outer tube made of resin; and
a fabric reinforcement layer interposed between the inner tube and the outer tube,
the fabric reinforcement layer comprising a first directional reinforcement member and a second directional reinforcement member which intersect each other, the first directional reinforcement member and the second directional reinforcement member each comprising one strand of thread obtained by doubling two or more strands of threads which are different in thickness or twisting number from each other, the first and second directional reinforcement members being woven or knitted with each other.

4. The resin hose according to claim 1, wherein the threads of the first and second directional reinforcement members are formed in the same over and under pattern.

5. The resin hose according to claim 1, wherein the threads of the first and second directional reinforcement members are formed in different over and under patterns.

6. The resin hose according to claim 2, wherein the threads of the first and second directional reinforcement members are formed in the same over and under pattern.

7. The resin hose according to claim 3, wherein the threads of the first and second directional reinforcement members are formed in the same over and under pattern.

8. The resin hose according to claim 2, wherein the threads of the first and second directional reinforcement members are formed in different over and under patterns.

9. The resin hose according to claim 3, wherein the threads of the first and second directional reinforcement members are formed in different over and under patterns.
